(19) United States
(12) Patent Application Publication
(10) Pub. No.: US 2009/0122003 A1
(43) Pub. Date: May 14, 2009

(54) DRIVING DEVICE FOR BACKLIGHT MODULE AND DISPLAY DEVICE THEREOF

(75) Inventors: Hung-Hsiang Chen, Taipei County (TW); Yi-Nan Chu, Changhua Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 12/191,298

(22) Filed: Aug. 13, 2008

(30) Foreign Application Priority Data
Nov. 8, 2007 (TW) 96142186

(51) Int. Cl. G09G 3/36; H05B 41/36

(52) U.S. Cl. 345/102; 315/307

(57) ABSTRACT

A display device and a driving device for driving a backlight module are provided. The driving device includes a power conversion circuit (PCC), a PWM generator, a current control unit (CCU) and a voltage feedback compensation circuit (VFCC). The PCC is used for converting an input voltage into an adjustable voltage supplied to the backlight module. The CCU is used for controlling current flowing through the backlight module. The VFCC is used for receiving an output voltage from the backlight module and providing a feedback voltage to the PWM generator, so that the PWM generator adjusts the adjustable voltage accordingly. Therefore, the driving device submitted by the present invention can be reduced the entire power consumption of the display device and further avoided the current control unit happened damage also.

### CROSS-REFERENCE TO RELATED APPLICATION

This application claims the priority benefit of Taiwan application serial no. 96142186, filed on Nov. 8, 2007. The entirety of the above-mentioned patent application is hereby incorporated by reference herein and made a part of specification.

### BACKGROUND OF THE INVENTION

1. Field of the Invention

The present invention generally relates to a backlight module for a display device and a display panel, and more particularly, to a device supplying a voltage to a backlight module.

2. Description of Related Art

As video technology is being developed, liquid crystal display (LCD) devices are widely used as displaying screens for consumer products such as cellular phones, laptop computers, personal computers, and personal digital assistants (PDAs). An LCD panel does not emit light by itself. As such, it needs a backlight module disposed thereunder to provide plane light source so that the LCD panel can display images.

FIG. 1 illustrates a structural diagram of a driving circuit of a conventional backlight module for an LCD device. Referring to FIG. 1, there is shown a driving circuit including a direct current to direct current (DC-to-DC) circuit 10, a light emitting diode (LED) backlight module 20, and a current control unit 30. The DC-to-DC circuit 10 includes an inductor 101, a diode 102, a capacitor 103, resistors 104, 105, and a pulse width modulation (PWM) generator 106. The inductor 101, the diode 102, and the capacitor 103 compose a boost circuit. The resistors 104 and 105 provide a feedback voltage to the PWM generator 106. The PWM generator 106 is adapted for determining an output voltage of the boost circuit. In this way, the DC-to-DC circuit 10 converts an input voltage Vᵢₙ to a stable voltage V_{L}, and provides the stable voltage V_{L} to the LED backlight module 20 for use.

The LED backlight module 20 includes a plurality of sets of serially connected LEDs. Each set of serially connected LED includes a plurality of LEDs 107 serially connected. The current control unit 30 is adapted for controlling current flowing through each set of serially connected LED.

FIGS. 2A and 2B describe characteristic curves of a conventional LED diode. Referring to FIG. 2A, when operating with a fixed current, a forward voltage V_{f} of the LED 107 decreases when a temperature of the LED 107 or an ambient temperature Tₐ rises. Referring to FIG. 2B, there is shown a curve A illustrating a correlation between the forward voltage V_{f} and a forward current I_{f} of the LED 107 when Tₐ is 25° C. It should be noted that Tₐ affects the correlation between the forward voltage V_{f} and a forward current I_{f} of the LED 107. In other words, when Tₐ is higher than 25° C., the curve A ascends to become for example a curve B; or otherwise when Ta is lower than 25° C., the curve A descends to become for example a curve C. In this manner, Tₐ affects the characteristics of the LED 107.

However, when the LED 107 is being operated, it inevitably liberates heat and causes Tₐ to rise, causing several problems. Referring to FIG. 1 again, when the current control unit 30 has not any fixed current mechanism within to maintain the current flowing through each LED 107 as fixed current and the stable voltage V_{L} remains as originally set, the forward voltage V_{f} of the LED 107 decreases when Ta rises, while the forward current I_{f} increases when Ta rises as shown in FIG. 2B.

For example, suppose an original status of the LED 107 in which Tₐ is 25° C., the stable voltage V_{L} is 9.9 V, the forward voltage V_{f} of the LED 107 is 3.3 V, and the forward current I_{f} is 20 mA. If Tₐ rises and the forward voltage V_{f} of the LED 107 is maintained at 3.3 V, the forward current I_{f} may increase to 25 mA. As such, a lifetime of the LED 107 may be shortened due to the increased forward current I_{f}. In addition, the increased forward current I_{f} even increases the load of the driving circuit mentioned the above, and thus the components within the driving circuit may cause damage.

In order to eliminate the risk of increasing the forward current I_{f} and shortening the lifetime of the LED 107 thereby, according to a conventional technology, the current control unit 30 typically maintains the current flowing through each set of serially connected LED as a fixed current. Unfortunately, that raises more serious problems. Because the current flowing through each set of serially connected LED is maintained fixed, when Tₐ rises, forward voltages V_{f} of each LEDs 107 in each set of serially connected LED decreases. Meanwhile, if the stable voltage V_{L} remains unchanged, a rest voltage drop of the stable voltage V_{L} will be transferred to the current control unit 30, and likely to damage the current control unit 30.

For example, suppose an original status of the LED 107 in which Tₐ is 25° C., the stable voltage V_{L} is 9.9. V, the forward voltage V_{f} of the LED 107 is 3.3 V, and the forward current I_{f} is 20 mA. If Tₐ rises and the forward current I_{f} is maintained at 20 mA, the forward voltage V_{f} of the LED 107 may drop to 3.0 V. A voltage drop of 0.9 V is then transferred to the current control unit 30. In such a way, the current control unit 30 may be damaged.

As such, it becomes a major concern for display manufacturers to find out solutions of the above difficulties.

### SUMMARY OF THE INVENTION

Accordingly, the present invention is directed to a driving device for a backlight module, which is adapted for preventing lifetimes of the backlight module from being shortened by regulating an output voltage of power conversion circuit.

The present invention is also directed to a driving device for a backlight module, which is adapted to control a power supplying to the backlight module by a manner of feeding back the output voltage of the backlight module, so as to avoid unnecessary power consumption.

The present invention is also directed to a display device, which is adapted for avoiding a current control unit happened damage by regulating a power supplying to the backlight module.

The present invention is also directed to a display device, which is adapted to regulate a power supplying to the backlight module by a manner of feeding back the output voltage of the backlight module, so as to prevent adding load to the driving circuit and avoid damaging the component within the driving circuit.

The present invention provides a driving device for a backlight module including a power conversion circuit, a PWM generator, a current control unit, and a voltage feedback compensation circuit. The power conversion circuit converts an input voltage into an adjustable voltage. The PWM generator is coupled to the power conversion circuit for adjusting the adjustable voltage. The current control unit is coupled to an output terminal of the backlight module for controlling a current flowing through the backlight module. The voltage feedback compensation circuit is coupled between the output terminal of the backlight module and the PWM generator for receiving an output voltage outputted from the output terminal of the backlight module, and providing a feedback voltage to the PWM generator. The PWM generator compares the feedback voltage with a reference voltage, and regulating a PWM signal according to a comparing result so as to adjust the adjustable voltage.

According to an embodiment of the present invention, the PWM generator of the backlight module includes an error amplifier, an oscillator, a slope compensation unit, a comparator, a controlling logic, and a transistor. The error amplifier includes a first input terminal receiving the feedback voltage, a second input terminal receiving the reference voltage, and an output terminal outputting a voltage adjusting signal. The oscillator is adapted to provide an oscillation signal. The slope compensation unit is adapted for-receiving the oscillation signal and adjusting a waveform of the oscillation signal. The comparator includes a first input terminal coupled to the output terminal of the error amplifier for receiving the voltage adjusting signal, a second input terminal coupled to the slope compensation unit for receiving the oscillation signal, and an output terminal for outputting a comparison signal. The control logic is coupled to the output terminal of the comparator, and is adapted to output a control signal according to the comparison signal. The transistor includes a first terminal coupled to the power conversion circuit, a second terminal coupled to a first voltage, and a gate terminal coupled to the control logic and receiving the control signal for determining whether to conduct the transistor so as to adjust the adjustable voltage.

According to an embodiment of the present invention, the voltage feedback compensation circuit of the foregoing driving device for backlight module includes an amplifier, a first resistor, and a second resistor. The amplifier includes a first input terminal receiving the output voltage, a second input terminal, and an output terminal coupled to the PWM generator. The first resistor includes a first terminal coupled to the output terminal of the amplifier, and a second terminal coupled to the second input terminal of the amplifier. The second resistor includes a first terminal coupled to a third voltage, and a second terminal coupled to the second input terminal of the amplifier.

The present invention provides a driving device for a backlight module including a power conversion circuit, a PWM generator, and a current control unit. The power conversion circuit converts an input voltage into an adjustable voltage. The PWM generator is coupled to the power conversion circuit for adjusting the adjustable voltage. An output terminal of the backlight module outputs a feedback voltage to the PWM generator. The current control unit is coupled to the output terminal of the backlight module for controlling current flowing through the backlight module. The PWM generator compares the feedback voltage with a reference voltage, and adjusts the adjustable voltage by regulating the PWM signal.

The present invention provides a display device including a power conversion circuit, a PWM generator, a backlight module, a display panel, a current control unit, and a voltage feedback compensation circuit. The power conversion circuit converts an input voltage into an adjustable voltage. The PWM generator is coupled to the power conversion circuit for adjusting the adjustable voltage. The backlight module receives the adjustable voltage for supplying a light source. The display panel changes a light transmittivity thereof according to a driving voltage of video data and displaying images collocated with the light source. The current control unit is coupled to an output terminal of the backlight module for controlling the current flowing through the backlight module. The voltage feedback compensation circuit is coupled between an output terminal and the PWM generator for receiving the output voltage from the output terminal of the backlight module, and providing a feedback voltage to the PWM generator. The PWM generator compares the feedback voltage with a reference voltage, and regulates a PWM signal according to a comparison result to adjust the adjustable voltage.

The present invention provides a display device including a power conversion circuit, a PWM generator, a backlight module, a display panel, and a current control unit. The power conversion circuit converts an input voltage into an adjustable voltage. The PWM generator is coupled to the power conversion circuit for adjusting the adjustable voltage. The backlight module receives the adjustable voltage for supplying a light source, and outputting a feedback voltage to the PWM generator. The display panel alternates a light transmittivity thereof according to a driving voltage of video data and displaying images collocated with the light source. The current control unit is coupled to an output terminal of the backlight module for controlling the current flowing through the backlight module. The PWM generator compares the feedback voltage with a reference voltage, and regulates a PWM signal according to a comparison result to adjust the adjustable voltage.

The present invention employs a power conversion circuit to provide an adjustable voltage to the backlight module, and employs a PWM generator to monitor an output voltage of the backlight module for regulating a PWM signal generated by the PWM generator, and thus adjusting the adjustable voltage according to the PWM signal. Thus, the entire power consumption of the display device can be reduced and is thus adapted to avoid the damage of the current control unit.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a structural diagram of a driving circuit of a conventional backlight module for an LCD device.

FIGS. 2A and 2B describe characteristic curves of a conventional LED diode.

FIG. 3 is a schematic diagram illustrating a display device according to a first embodiment of the present invention.

FIG. 4 is a structural diagram illustrating a power conversion circuit according to the first embodiment of the present invention.

FIG. 5 is a structural diagram illustrating a backlight module according to the first embodiment of the present invention.

FIG. 6 is a structural diagram illustrating a voltage feedback compensation circuit according to the first embodiment of the present invention.

FIG. 7 is a structural diagram illustrating a PWM generator according to the first embodiment of the present invention.

FIG. 8 is a schematic diagram illustrating a display device according to a second embodiment of the present invention.

FIG. 9 is a structural diagram illustrating a PWM generator according to the second embodiment of the present invention.

FIG. 10 is a schematic diagram illustrating a display device having a function of adjusting a reference voltage according to the second embodiment of the present invention.

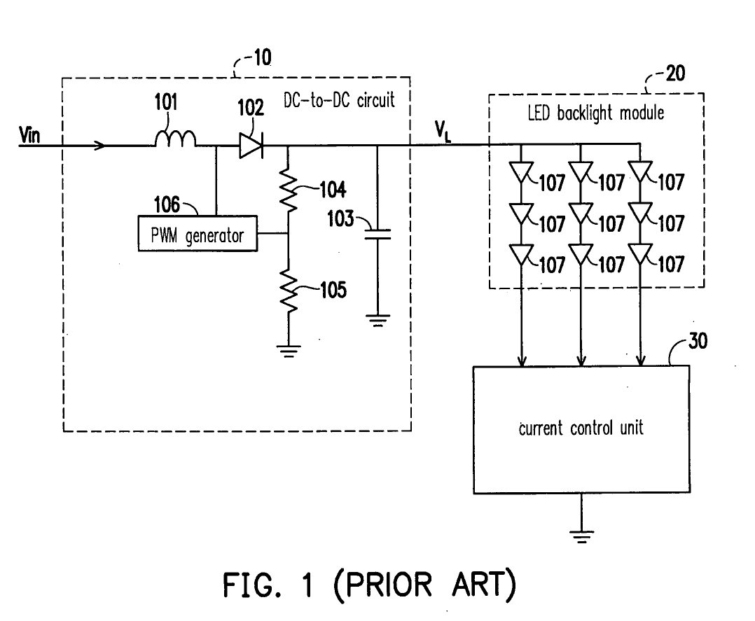

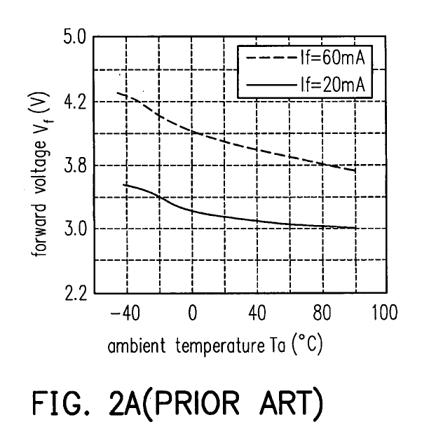

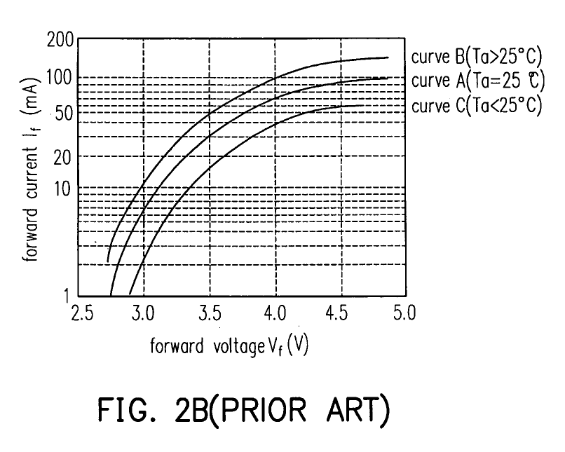

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

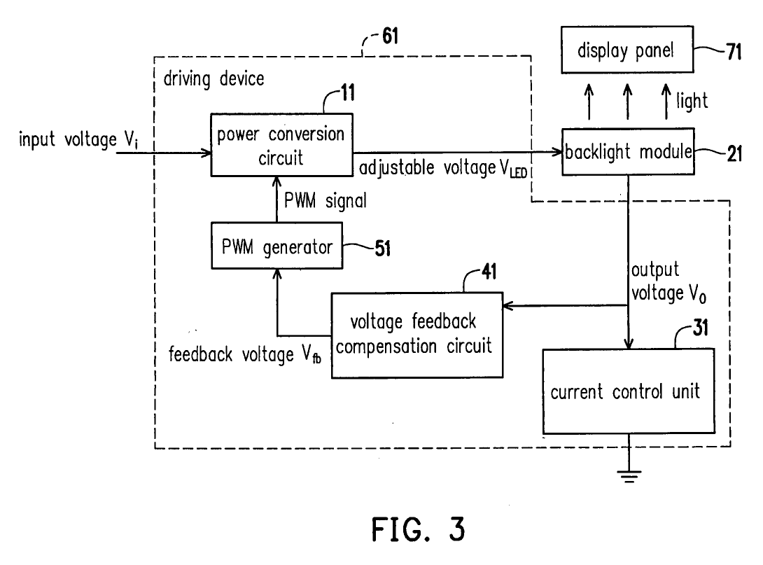

FIG. 3 is a schematic diagram illustrating a display device according to a first embodiment of the present invention. Referring to FIG. 3, there is shown a display device including a driving device 61 for a backlight module, a backlight module 21, and a display panel 71. According to the embodiment, the display panel 71 is exemplified with an LCD panel. The driving device 61 for the backlight module 21 includes a power conversion circuit 11, a PWM generator 51, a current control unit 31, and a voltage feedback compensation circuit 41. The power conversion circuit 11 converts an input voltage Vᵢ into an adjustable voltage V_{LED}. The PWM generator 51 regulates a PWM signal for adjusting the adjustable voltage V_{LED}. The backlight module 21 receives the adjustable voltage V_{LED}, and emits light correspondingly. The current control unit 31 is adapted for controlling a current flowing through the backlight module 21.

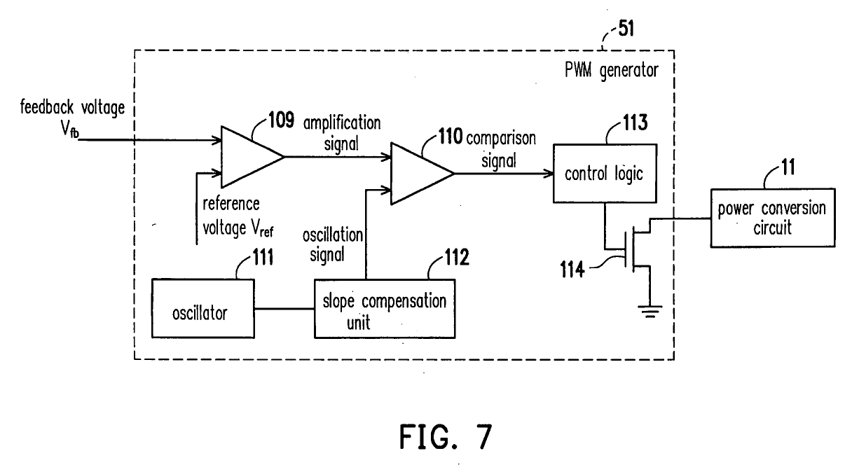

Characteristics of the backlight module 21 is subject to be affected by Tₐ. Accordingly, the voltage feedback compensation circuit 41 is used for receiving an output voltage Vₒ outputted from an output terminal of the backlight module 21, and providing a feedback voltage V_{fb} to the PWM generator 51. The PWM generator 51 is adapted for comparing the feedback voltage V_{fb} with a reference voltage V_{ref} (can be referred from FIG. 7), and regulating the PWM signal according to the comparison result to adjust the adjustable voltage V_{LED}. According to the embodiment, the reference voltage V_{ref} is provided by an internal preset voltage of the PWM generator 51. In this way, unnecessary power consumption can be avoided. Each component of the driving device 61 can be further described herebelow in more detail.

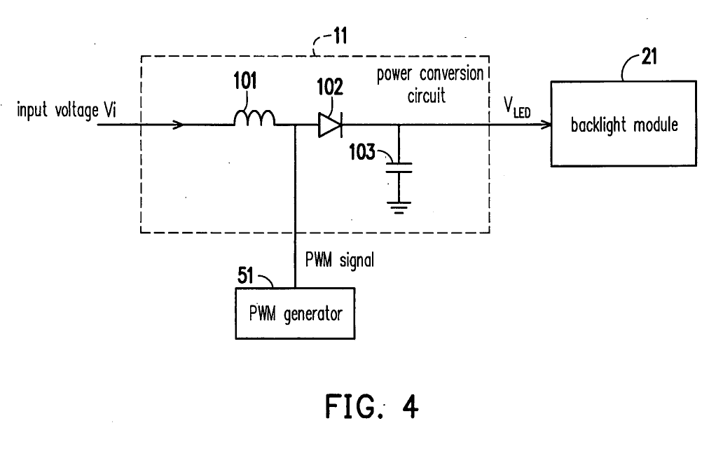

FIG. 4 is a structural diagram illustrating a power conversion circuit according to the first embodiment of the present invention. Referring to FIGS. 3 and 4 together, as shown in FIG. 4, there is shown a power conversion circuit 11 including an inductor 101, a diode 102 and a capacitor 103. The power conversion circuit 11 is adapted to convert the input voltage Vᵢ into the adjustable voltage V_{LED}. The power conversion circuit 11 is further adapted for adjusting the adjustable voltage V_{LED} according to the PWM signal outputted from the PWM generator 51. Other approaches may be also implemented by those of ordinary skill in the art to realize the power conversion circuit according to the teachings of the present invention, which also construed to be within the scope of the present invention and are not to be discussed hereby.

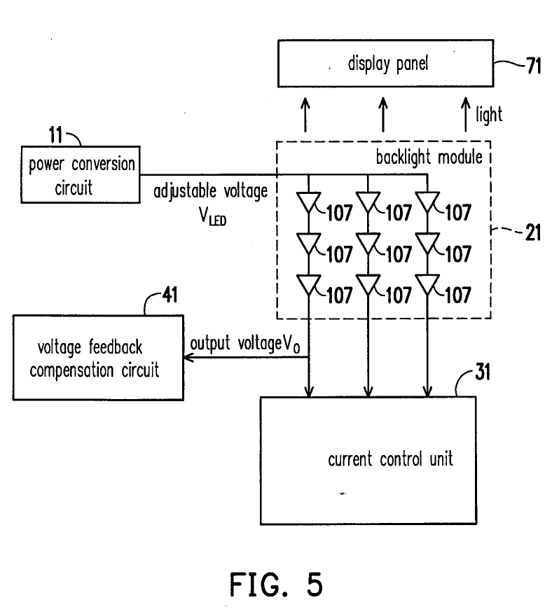

FIG. 5 is a structural diagram illustrating a backlight module according to the first embodiment of the present invention. Referring to FIGS. 3 and 5, the backlight module 21 according to the embodiment is exemplified with an LED backlight module. The backlight module 21 includes a plurality of sets of serially connected LED. In this embodiment, it is illustrated taking three sets of serially connected LED as an example. Each set of serially connected LED is composed of a plurality of LEDs serially connected in an order. In this embodiment, it is illustrated taking a set of serially connected LED including three LEDs 107 as an example. Each set of serially connected LED of the backlight module 21 receives the adjustable voltage V_{LED} and thus provides a light source to the display panel 71. Those of ordinary skill in the art would understand that the LED backlight module is employed herein merely to describe an embodiment of the present invention, in other embodiments, the backlight module 21 may be known light emitting components which may be affected by Tₐ, and the scope of the present invention is not intended to be limited by the above embodiment.

Referring to FIG. 3, a light transmittivity of the display panel 71 is changed by a driving voltage of video data, and then the display panel 71 collocates with the light source provided by the backlight module 21 to display images. The current control unit 31 is used to control a current flowing through the backlight module 21. According to an aspect of the embodiment, a forward current I_{f} of the LED 107 flowing through the backlight module 21 is a fixed current, while according to another embodiment of the present invention, a forward current I_{f} of the LED 107 flowing through the backlight module 21 is an unfixed current.

It should be noted that when Tₐ rises, a forward voltage V_{f} of the LED 107 of the backlight module 21 decreases, and therefore the output voltage Vₒ increases. For example, if an original value of the adjustable voltage V_{LED} is 9.9 V, and the forward voltage V_{f} of the LED 107 is 3.3 V, in that the forward voltage of the backlight module 21 is 3×3.3=9.9 V, the output voltage Vₒ is 0 V.

However, when Tₐ rises, the forward voltage V_{f} of the LED 107 may drop to 3.0 V, in that the forward voltage of the backlight module 21 is 3×3.0=9 V, and therefore the output voltage Vₒ is 0.9 V. A long time maintained output voltage Vₒ at 0.9 V not only wastes power, but also may cause damage to the current control unit 31.

In order to recover the output voltage Vₒ back to 0 V, the voltage feedback compensation circuit 41 is employed to receive the output voltage Vₒ from the output terminal of the backlight module 21. Then the voltage feedback compensation circuit 41 provides a feedback voltage V_{fb} to the PWM generator 51. The PWM generator 51 compares the V_{fb} with the reference voltage V_{ref}, and regulates the PWM signal according to the comparison result to adjust the adjustable voltage V_{LED}. In such a way, the adjustable voltage V_{LED} can be decreased from 9.9 V to 9.0 V, the output voltage Vₒ can be decreased from 0.9 V to 0 V, and therefore avoiding wastage of power. It is well known to those having ordinary skill in the art that voltage feedback compensation circuits 41 and PWM generators 51 manufactured by different manufacturers are different, which may be applied to the present invention according to the specification of the selected products and their practical requirements. A structure of the voltage feedback compensation 41 and the PWM generator 51 according to the present invention is described as follows.

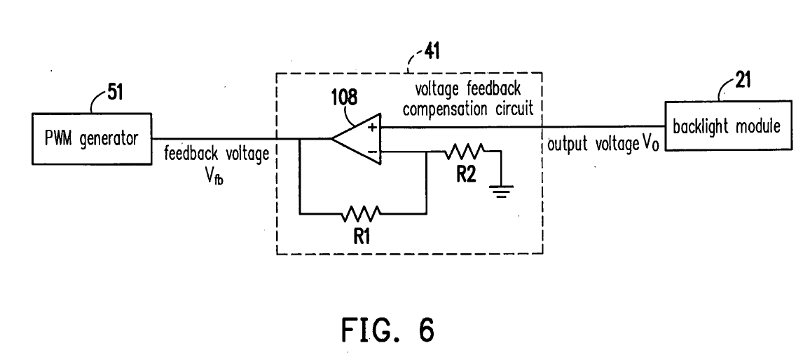

FIG. 6 is a structural diagram illustrating a voltage feedback compensation circuit according to the first embodiment of the present invention. Referring to FIGS. 3 and 6, as shown in FIG. 6, there is shown a voltage feedback compensation circuit including an amplifier 108, a resistor R1, and a resistor R2. First, a value of a reference output voltage (V_{oref}) can be set according to characteristics of the LED 107. The reference output voltage (V_{oref}) is an ideal value of the output voltage Vₒ. The reference output voltage (V_{oref}) can be set by those having ordinary skill in the art according to their practical requirement. An equation (1) is given below exemplifies the setting of the reference output voltage V_{oref}.

The reference output voltage V_{oref}=amount of LEDs of a set of serially connected LED×[V_{f(max)}−V_{f(min)}] (1)

In the equation (1), V_{f(max)} is an upper limit of an operational voltage range of the LED 107, for example, about 3.6 V, and V_{f(min)} is a lower limit of an operational voltage range of the LED 107, for example, about 3.0 V. In the present embodiment, the reference output voltage V_{oref} is exemplified with for example 1.8 V. Those of ordinary skill in the art would be able to determine the value of the reference output voltage V_{oref} according to the practical requirement.

Furthermore, the reason of setting the reference output voltage V_{oref} is that when the output voltage Vₒ being affected by Tₐ exceeds the reference output voltage V_{oref}, the driving device 61 will adjust the adjustable voltage V_{LED}. Each LED 107 when being operated works in a different voltage range. Accordingly, setting the reference output voltage V_{oref} with equation (1) can advantageously avoid the LEDs 107 exceed their operation voltage range.

The reference voltage V_{ref} is provided by an internal preset voltage of the PWM generator 51. However, those of ordinary skill in the art would be aware of setting the preset voltage as practically needed. In other words, the reference voltage V_{ref} is a known value. The embodiment exemplifies the present invention with a reference voltage V_{ref} having a value of 1.24 V. The resistors R1 and R2 can be designed with equation (2) as below.

Reference voltage V_{ref}=reference output voltage V_{oref}×(1+R1/R2) (2)

According to the equation (2), resistances of the resistors R1 and R2 can be selected according to practical requirement, if only the ratio therebewteen satisfies equation (2).

FIG. 7 is a structural diagram illustrating a PWM generator according to the first embodiment of the present invention. Referring to FIGS. 3 and 7, as shown in FIG. 7, there is illustrated an application of a PWM generator 51. In this embodiment, the PWM generator 51 includes an error amplifier 109, an oscillator 111, a slope compensation unit 112, a comparator 110, a logic control 113, and a transistor 114. The error amplifier 109 includes a first input terminal for receiving a feedback voltage V_{fb}, a second input terminal for receiving a reference voltage V_{ref}, and an output terminal for outputting a voltage adjusting signal. The oscillator 111 is adapted to provide an oscillation signal, for example a sine wave. The slope compensation unit 112 receives the oscillation signal and adjusts a waveform of the oscillation wave, for example adjusting a sine wave into a triangular wave.

Furthermore, the comparator 110 includes a first input terminal for receiving the voltage adjusting signal, a second input terminal for receiving the oscillation signal, and an output terminal for outputting a comparison signal. The control logic 113 outputs a control signal according to the comparison signal. The transistor 114 includes a gate terminal receiving the control signal for determining whether to conduct the transistor, and further adjusting the adjustable voltage V_{LED}. In such a way, the output voltage Vₒ is recovered to 0 V, and thus unnecessary power consumption and damage to the current control unit 31 can be avoided.

According to the foregoing embodiments, the reference voltage V_{ref} is provided by the internal preset voltage of the PWM generator 51. In other embodiments, the preset voltage of the PWM generator 51 can be adjusted, or an external circuit can be further introduced for providing the reference voltage V_{ref}.

Those of ordinary skill in the art may set the foregoing reference output voltage V_{oref}, resistors R1, R2, the feedback voltage V_{fb}, and the reference voltage V_{ref} as practically needed. In other words, the scope of the present invention includes that as long as the output voltage Vₒ of the backlight module 21 is monitored by a way of feedback and thereby providing the adjustable voltage V_{LED} to the backlight module 21.

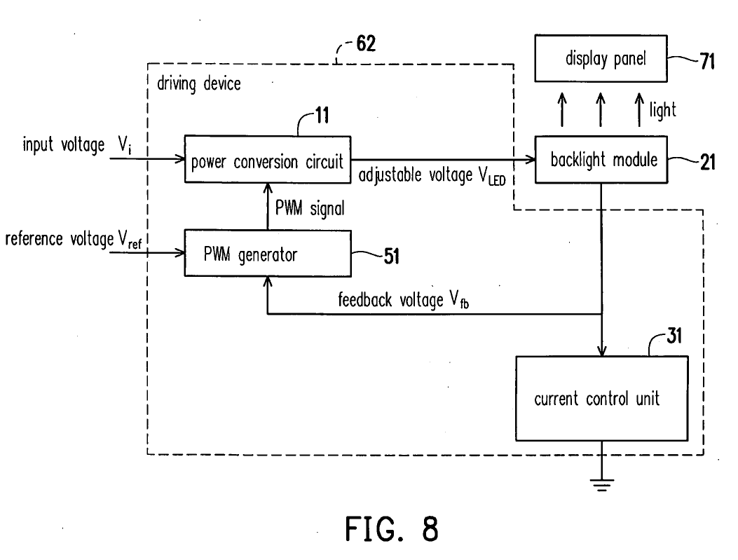

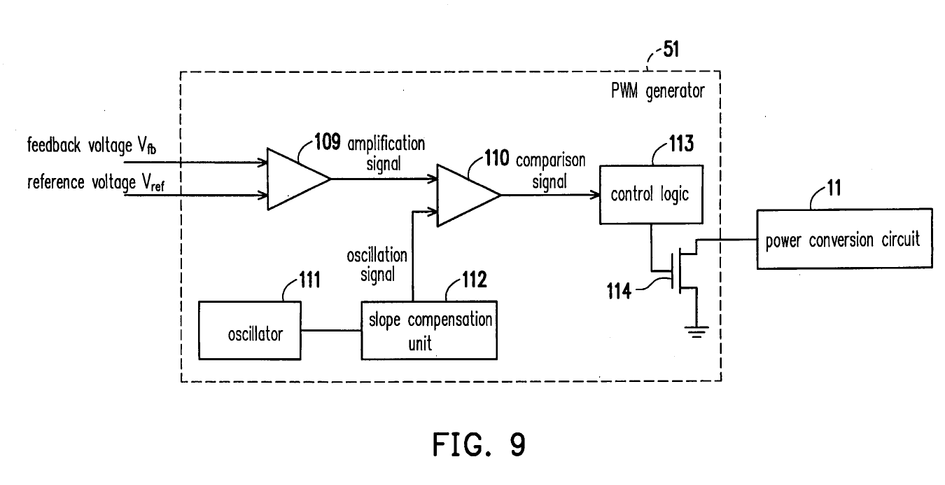

FIG. 8 is a schematic diagram illustrating a display device according to a second embodiment of the present invention. FIG. 9 is a structural diagram illustrating a PWM generator according to the second embodiment of the present invention. Referring to FIGS. 8 and 9, there is shown a display device including a driving device 62 for the backlight module, a backlight module 21, and a display panel 71. The driving device 62 includes a power conversion circuit 11, a PWM generator 51, and a current control unit 31. The display panel 71, the power conversion circuit 11, the PWM generator 51, the backlight module 21 and current control unit 31 can be learnt by referring to FIG. 3 and the description thereof, and is not to be iterated hereby. The embodiment differs from FIG. 3 in that the voltage compensation circuit 41 is omitted. The backlight module 21 directly outputs a feedback voltage V_{fb}, namely the output voltage Vo of the backlight module 21, to the error amplifier 109 of the PWM generator 51. By comparing the feedback voltage V_{fb} and the reference voltage V_{ref}, the PWM generator adjusts the adjustable voltage V_{LED} for providing to the backlight module 21. The reference voltage V_{ref} is determined by an upper limit and a lower limit of an operation voltage range of a set of serially connected LED. For example, the reference voltage V_{ref} can be determined according to equation (3) as below.

Reference voltage V_{ref}=amount of LEDs of a set of serially connected LED×(V_{f(max)}−V_{f(min)}) (3).

In equation (3), V_{f(max)} represents the upper limit of an operation voltage range of an LED being operated, and V_{f(min)} represents the lower limit of an operation voltage range of an LED being operated. Those of ordinary skill in the art would be able to determine the value of the reference voltage V_{ref}, as the threshold for adjusting the adjustable voltage V_{LED}.

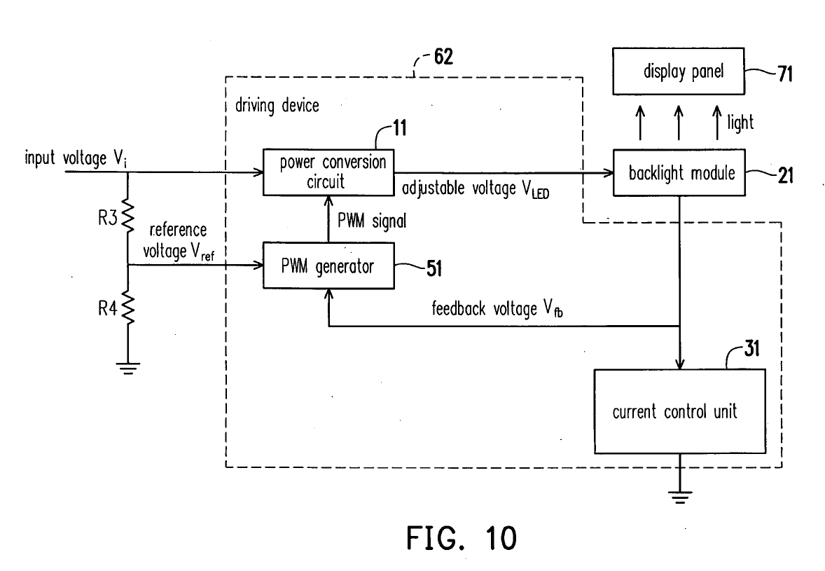

Those of ordinary skill in the art may provide the reference voltage V_{ref} to the PWM generator 51 in other ways according to the practical requirement. FIG. 10 is a schematic diagram illustrating a display device having a function of adjusting a reference voltage according to the second embodiment of the present invention. Referring to FIG. 10, there is shown voltage dividing resistors R3 and R4 serving adjustable resistors for illustrating the present invention, in other embodiments, fixed resistors may be used. The voltage dividing resistor R3 has a first terminal coupled to an input voltage Vᵢ, and a second terminal coupled to a first terminal of the voltage dividing resistor R4 and the PWM generator 51, and a second terminal of the voltage dividing resistor R4 are coupled to a zero potential voltage (in other embodiments, other potentials may be coupled to). The voltage dividing resistors R3 and R4 are adapted for providing the reference voltage V_{ref} to the PWM generator 51. In such a way, the PWM generator 51 compares the feedback voltage V_{fb} with the reference voltage V_{ref}, and regulates the PWM signal according to the comparison result, and thus adjusts the adjustable voltage V_{LED}.

Thus, both power consumption and damage to the current control unit can be avoided, and the cost of the voltage feedback compensation circuit 41 can be saved.

In summary, the present invention has at least the following advantages.
1. utilizing a voltage feedback compensation circuit to monitor an output voltage of the backlight module, and then comparing the feedback voltage with the reference by a PWM generator, so that the PWM generator regulates the PWM signal generated by itself to adjust the adjustable voltage provided to the backlight module according to the comparison result, so that the entire power consumption of the display device and the load of the driving circuit for driving backlight module can be reduced, and further the current control unit happened damage can be avoided also;
2. feeding back the output voltage from the backlight module to the PWM generator, the PWM generator comparing the feedback voltage with a reference voltage, and regulating the PWM signal according to the comparison result, not only avoiding unnecessary power consumption, damage to the current control unit, and additional load on the driving circuit, but also saving cost for the voltage feedback compensation circuit.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving device for a backlight module, comprising:
a power conversion circuit, converting an input voltage into an adjustable voltage;
a pulse width modulation (PWM) generator, coupled to the power conversion circuit, for adjusting the adjustable voltage;
a current control unit, coupled to an output terminal of the backlight module, for controlling current flowing through the backlight module; and
a voltage feedback compensation circuit, coupled between the output terminal of the backlight module and the PWM generator, for receiving an output voltage from the output terminal of the backlight module and providing a feedback voltage to the PWM generator, wherein the PWM generator compares the feedback voltage with a reference voltage, and regulates a PWM signal according to a comparison result so as to adjust the adjustable voltage.

2. The driving device for a backlight module according to claim 1, wherein the PWM generator comprises:
an error amplifier, comprising a first input terminal receiving the feedback voltage, a second input terminal receiving the reference voltage, and an output terminal outputting a voltage adjusting signal;
an oscillator, adapted for providing an oscillation signal;
a slope compensation unit, adapted for receiving the oscillation signal and adjusting a waveform of the oscillation signal;
a comparator, comprising a first input terminal coupled to the output terminal of the error amplifier for receiving the voltage adjusting signal, a second input terminal coupled to the slope compensation unit for receiving the oscillation signal, and an output terminal for outputting a comparison signal;
a controlling logic, coupled to the output terminal of the comparator, for outputting a control signal according to the comparison signal; and
a transistor, comprising a first terminal coupled to the power conversion circuit, a second terminal coupled to a first voltage, and a gate terminal coupled to the control logic and receiving the control signal for determining whether to conduct the transistor so as to adjust the adjustable voltage.

3. The driving device for a backlight module according to claim 1, wherein the power conversion circuit comprises:
an inductor, comprising a first terminal and a second terminal, the first terminal receiving the input voltage;
a diode, comprising an input terminal and an output terminal, the input terminal being coupled to the second terminal of the inductor and the PWM generator, the output terminal being coupled to the backlight module; and
a capacitor, comprising a first terminal and a second terminal, the first terminal being coupled to the output terminal of the diode, and the second terminal being coupled to a second voltage.

4. The driving device for a backlight module according to claim 1, wherein the backlight module comprises:
a plurality of sets of serially connected LED, each set of serially connected LED being composed of a plurality of LEDs serially connected to receive the adjustable voltage.

5. The driving device for a backlight module according to claim 1, wherein the voltage feedback compensation circuit comprises:
an amplifier, comprising a first input terminal receiving the output voltage, a second input terminal, and an output terminal coupled to the PWM generator;
a first resistor, comprising a first terminal coupled to the output terminal of the amplifier, and a second terminal coupled to the second input terminal of the amplifier; and
a second resistor, comprising a first terminal coupled to a third voltage, and a second terminal coupled to the second input terminal of the amplifier.

6. The driving device for a backlight module according to claim 5, wherein the reference voltage is determined by a reference output voltage and a ratio between the first resistor and the second resistor, wherein the reference output voltage is an ideal value of the output voltage.

7. The driving device for a backlight module according to claim 1, wherein the current control unit is adapted for maintaining the current flowing through the backlight module as a fixed current.

8. The driving device for a backlight module according to claim 1, wherein a forward voltage of the backlight module decreases when a temperature of the backlight module rises.

9. A driving device for a backlight module, comprising:
a power conversion circuit, adapted for converting an input voltage into an adjustable voltage;
a PWM generator, coupled to the power conversion circuit for adjusting the adjustable voltage, wherein an output terminal of the backlight module outputs a feedback voltage to the PWM generator; and
a current control unit, coupled to an output terminal of the backlight module, for controlling a current flowing through the backlight module;
wherein the PWM generator compares the feedback voltage with a reference voltage, and regulating a PWM signal according to a comparing result so as to adjust the adjustable voltage.

10. The driving device for a backlight module according to claim 9, wherein the PWM generator comprises:
an error amplifier, comprising a first input terminal receiving the feedback voltage, a second input terminal receiving the reference voltage, and an output terminal outputting a voltage adjusting signal;
an oscillator, adapted for providing an oscillation signal;
a slope compensation unit, adapted for receiving the oscillation signal and adjusting a waveform of the oscillation signal;
a comparator, comprising a first input terminal coupled to the output terminal of the error amplifier for receiving the voltage adjusting signal, a second input terminal coupled to the slope compensation unit for receiving the oscillation signal, and an output terminal for outputting a comparison signal;
a controlling logic, coupled to the output terminal of the comparator, and adapted to output a control signal according to the comparison signal; and
a transistor, comprising a first terminal coupled to the power conversion circuit, a second terminal coupled to a first voltage, and a gate terminal coupled to the control logic and receiving the control signal for determining whether to conduct the transistor so as to adjust the adjustable voltage.

11. The driving device for a backlight module according to claim 9, wherein the power conversion circuit comprises:
an inductor, comprising a first terminal and a second terminal, the first terminal receiving the input voltage;
a diode, comprising an input terminal and an output terminal, the input terminal being coupled to the second terminal of the inductor and the PWM generator, the output terminal being coupled to the backlight module; and
a capacitor, comprising a first terminal and a second terminal, the first terminal being coupled to the output terminal of the diode, and the second terminal being coupled to a second voltage.

12. The driving device for a backlight module according to claim 9, wherein the backlight module comprises:
a plurality of sets of serially connected LED, each set of serially connected LED being composed of a plurality of LEDs serially connected to receive the adjustable voltage, and output a feedback voltage to the PWM generator.

13. The driving device for a backlight module according to claim 12, wherein the reference voltage is determined by a differential value between a maximum operating voltage and a minimum operating voltage of one set of serially connected LED.

14. The driving device for a backlight module according to claim 9, further comprising:
a first voltage dividing resistor, comprising a first terminal, and a second terminal, the first terminal receiving the input voltage; and
a second voltage dividing resistor, comprising a first terminal and a second terminal, the first terminal being coupled to the second terminal of the first voltage dividing resistor and the PWM generator, the second terminal being coupled to a fourth voltage so as to provide the reference voltage to the PWM generator.

15. The driving device for a backlight module according to claim 9, wherein the current control unit is adapted for maintaining the current flowing through the backlight module as a fixed current.

16. The driving device for a backlight module according to claim 9, wherein a forward voltage of the backlight module decreases when a temperature of the backlight module rises.

17. A display device, comprising:
a power conversion circuit, adapted for converting an input voltage into an adjustable voltage;
a PWM generator, coupled to the power conversion circuit, for adjusting the adjustable voltage;
a backlight module, for receiving the adjustable voltage to supply a light source;
a display panel, changing a light transmittivity thereof according to a driving voltage of video data and displaying images collocated with the light source;
a current control unit, coupled to an output terminal of the backlight module for controlling the current flowing through the backlight module; and
a voltage feedback compensation circuit, coupled between the output terminal of the backlight module and the PWM generator, for receiving the output voltage from the output terminal of the backlight module, and providing a feedback voltage to the PWM generator;
wherein the PWM generator compares the feedback voltage with a reference voltage, and regulates a PWM signal according to a comparison result so as to adjust the adjustable voltage.

18. The display device according to claim 17, wherein the PWM generator comprises:
an error amplifier, comprising a first input terminal receiving the feedback voltage, a second input terminal receiving the reference voltage, and an output terminal outputting a voltage adjusting signal;
an oscillator, adapted for providing an oscillation signal;
a slope compensation unit, adapted for receiving the oscillation signal and adjusting a waveform of the oscillation signal;
a comparator, comprising a first input terminal coupled to the output terminal of the error amplifier for receiving the voltage adjusting signal, a second input terminal coupled to the slope compensation unit for receiving the oscillation signal, and an output terminal for outputting a comparison signal;
a controlling logic, coupled to the output terminal of the comparator, for outputting a control signal according to the comparison signal; and
a transistor, comprising a first terminal coupled to the power conversion circuit, a second terminal coupled to a first voltage, and a gate terminal coupled to the control logic and receiving the control signal for determining whether to conduct the transistor so as to adjust the adjustable voltage.

19. The display device according to claim 17, wherein the power conversion circuit comprises:
an inductor, comprising a first terminal and a second terminal, the first terminal receiving the input voltage;
a diode, comprising an input terminal and an output terminal, the input terminal being coupled to the second terminal of the inductor and the PWM generator, the output terminal being coupled to the backlight module; and
a capacitor, comprising a first terminal and a second terminal, the first terminal being coupled to the output terminal of the diode, and the second terminal being coupled to a second voltage.

20. The display device according to claim 17, wherein the backlight module comprises:
a plurality of sets of serially connected LED, each set of serially connected LED being composed of a plurality of LEDs serially connected for receiving the adjustable voltage.

21. The display device according to claim 17, wherein the voltage feedback compensation circuit comprises:
an amplifier, comprising a first input terminal receiving the output voltage, a second input terminal, and an output terminal coupled to the PWM generator;
a first resistor, comprising a first terminal coupled to the output terminal of the amplifier, and a second terminal coupled to the second input terminal of the amplifier; and
a second resistor, comprising a first terminal coupled to a third voltage, and a second terminal coupled to the second input terminal of the amplifier.

22. The display device according to claim 21, wherein the reference voltage is determined by a reference output voltage and a ratio between the first resistor and the second resistor, wherein the reference output voltage is an ideal value of the output voltage.

23. The display device according to claim 17, wherein the current control unit is adapted for maintaining the current flowing through the backlight module as a fixed current.

24. The display device according to claim 17, wherein a forward voltage of the backlight module decreases when a temperature of the backlight module rises.

25. A display device, comprising:
a power conversion circuit, adapted for converting an input voltage into an adjustable voltage;
a PWM generator, coupled to the power conversion circuit, for adjusting the adjustable voltage;
a backlight module, for receiving the adjustable voltage to supply a light source;
a display panel, changing a light transmittivity thereof according to a driving voltage of video data and displaying images collocated with the light source; and
a current control unit, coupled to an output terminal of the backlight module for controlling the current flowing through the backlight module;
wherein the PWM generator compares the feedback voltage with a reference voltage, and regulates a PWM signal according to a comparison result so as to adjust the adjustable voltage.

26. The display device according to claim 25, wherein the PWM generator comprises:
an error amplifier, comprising a first input terminal receiving the feedback voltage, a second input terminal receiving the reference voltage, and an output terminal outputting a voltage adjusting signal;
an oscillator, adapted for providing an oscillation signal;
a slope compensation unit, adapted for receiving the oscillation signal and adjusting a waveform of the oscillation signal;
a comparator, comprising a first input terminal coupled to the output terminal of the error amplifier for receiving the voltage adjusting signal, a second input terminal coupled to the slope compensation unit for receiving the oscillation signal, and an output terminal for outputting a comparison signal;
a controlling logic, coupled to the output terminal of the comparator, for outputting a control signal according to the comparison signal; and
a transistor, comprising a first terminal coupled to the power conversion circuit, a second terminal coupled to a first voltage, and a gate terminal coupled to the control logic and receiving the control signal for determining whether to conduct the transistor so as to adjust the adjustable voltage.

27. The display device according to claim 25, wherein the power conversion circuit comprises:
an inductor, comprising a first terminal and a second terminal, the first terminal receiving the input voltage;
an diode, comprising an input terminal and an output terminal, the input terminal being coupled to the second terminal of the inductor and the PWM generator, the output terminal being coupled to the backlight module; and
a capacitor, comprising a first terminal and a second terminal, the first terminal being coupled to the output terminal of the diode, and the second terminal being coupled to a second voltage.

28. The display device according to claim 25, wherein the backlight module comprises:
a plurality of sets of serially connected LED, each set of serially connected LED being composed of a plurality of LEDs serially connected for receiving the adjustable voltage, and outputting a feedback voltage to the PWM generator.

29. The display device according to claim 28, wherein the reference voltage is determined by a differential value between a maximum operating voltage and a minimum operating voltage of one set of serially connected LCD.

30. The display device according to claim 25 further comprising:
a first voltage dividing resistor, comprising a first terminal, and a second terminal, the first terminal receiving the input voltage; and
a second voltage dividing resistor, comprising a first terminal and a second terminal, the first terminal being coupled to the second terminal of the first voltage dividing resistor and the PWM generator, the second terminal being coupled to a fourth voltage so as to provide the reference voltage to the PWM generator.

31. The display device according to claim 25, wherein the current control unit is adapted for maintaining the current flowing through the backlight module as a fixed current.

32. The display device according to claim 25, wherein a forward voltage of the backlight module decreases when a temperature of the backlight module rises.
